(19) United States
(12) Patent Application Publication
(10) Pub. No.: US 2014/0111479 A1
(43) Pub. Date: Apr. 24, 2014

(54) Interactive Three-Dimensional Display System

(71) Applicant: APPLE INC., Cupertino, CA (US)

(72) Inventors: Christoph H. Krah, Saratoga, CA (US); Marduke Yousefpor, San Jose, CA (US)

(73) Assignee: Apple Inc., Cupertino, CA (US)

(21) Appl. No.: 13/659,474

(22) Filed: Oct. 24, 2012

(51) Int. Cl. G06F 3/042

(52) U.S. Cl. 345/175

(57) ABSTRACT

An interactive display system may be provided that allows a user to interact with three-dimensional projected images that have been formed in mid-air. Display structures may be used to display a primary image. The display structures may include structures for creating a three-dimensional image such as a laser projection system that creates a three-dimensional image in a non-linear crystal or a three-dimensional display based on a rotating two-dimensional display or other three-dimensional display equipment. An optical system based on parabolic mirrors or lenses may be used to project the three-dimensional image that has been formed on the display structures into mid-air. A user may interact with the projected image. Sensors may use trilateration techniques to monitor the user's interactions. The projected image may be updated based on the user's interactions, thereby allowing the user to control and manipulate the projected image in mid-air.

### BACKGROUND

This relates generally to display systems, and, more particularly, to interactive three-dimensional display systems.

Three-dimensional (3D) display technologies are becoming increasingly popular. Growing interest in the applications of 3D viewing is evident not only in the field of computer graphics but also in a wide variety of other environments such as education, medical diagnostics, biomechanical engineering, etc.

Conventional 3D display systems typically require special viewing equipment. For example, observers may be required to wear special viewing equipment such as glasses, goggles, helmets, or other viewing aids in order to view the 3D image. This type of special viewing equipment can be cumbersome and undesirable for a viewer.

Autostereoscopic display technologies such as volumetric and parallax displays have been developed in attempt to produce 3D images to a viewer without the use of special viewing glasses or other viewing aids. However, conventional autostereoscopic display systems tend to have several drawbacks. For example, parallax display systems typically require a user to remain in a fixed location relative to the display, thereby preventing a user from viewing the 3D image from different viewing angles. Volumetric display systems are often incapable of producing images that exhibit occlusion and opacity, which in turn can cause 3D images to appear less realistic to a viewer. Volumetric display systems that are capable of reconstructing images with occlusion have been known to introduce vertical parallax, a type of image distortion that can result in user eyestrain.

Some free-space imaging displays project images onto an invisible surface such as a thin layer of fog. Advancements have been made in this field in an effort to improve the fidelity of the projected image. However, these display technologies inherently rely on the quality and stability of the projection medium, and it is difficult to prevent projection screen instability from causing image degradation. An additional drawback of the projection medium is that physical interaction with the projected image by an observer can disturb the projection medium and distort the projected image.

It would therefore be desirable to be able to provide improved interactive display systems for displaying 3D images.

### SUMMARY

An interactive display system may be provided that allows a user to interact with three-dimensional projected images that have been formed in mid-air.

The interactive display system may include display structures for producing a primary three-dimensional image. The display structures may include a laser projection system such as one or more infrared laser projectors that project an image into a non-linear optical material such as a non-linear crystal or the display structures may include other types of three-dimensional display technologies.

An optical system may be configured to project the three-dimensional image into mid-air to form a secondary three-dimensional image based on the primary three-dimensional image. The optical system may include an assembly of mirrors such as first and second curved mirrors. The primary three-dimensional image may be formed within the assembly of mirrors. Light from the primary three-dimensional image may be reflected between the first and second curved mirrors until it ultimately exits through an opening in one of the mirrors to form the projected three-dimensional image in mid-air.

The interactive display system may include a sensor system for gathering information on user interactions with the projected three-dimensional image. The sensor system may include an infrared light source such as an infrared laser and a network of sensors configured to detect infrared light. The infrared light source may emit infrared light towards the secondary three-dimensional image. The network of sensors may be configured to detect the light as it reflects off of an external object such as a user's finger. The sensor system may determine a location of the external object based on the signals detected by the network of sensors.

The information gathered by the sensor system may be interpreted as user input data. Control circuitry in the interactive display system may update the primary three-dimensional image based on the user input data. This may in turn update the secondary three-dimensional image projection. This type of feedback mechanism allows one or more users to interact with and provide user input to the projected three-dimensional image in mid-air.

Further features of the invention, its nature and various advantages will be more apparent from the accompanying drawings and the following detailed description of the preferred embodiments.

### BRIEF DESCRIPTION OF THE DRAWINGS

FIG. 1 is a diagram of an illustrative interactive three-dimensional display system in accordance with an embodiment of the present invention.

FIG. 2 is a schematic diagram of an illustrative interactive three-dimensional display system in accordance with an embodiment of the present invention.

FIG. 3 is a diagram of illustrative circuitry that may be used in a detection system for detecting user interaction with a projected image in accordance with an embodiment of the present invention.

FIG. 4 is a flow chart of illustrative steps involved in operating an interactive three-dimensional display system in accordance with an embodiment of the present invention.

### DETAILED DESCRIPTION

This relates generally to three-dimensional (3D) display systems and, more particularly, to interactive 3D display systems that produce 3D images in mid-air that can be interacted with by a user or other external object.

The 3D interactive display system may include a display system for creating a primary 3D image, an optical system for creating a secondary 3D image in mid-air based on the primary 3D image, and a sensor system for detecting user input as a user interacts with the secondary 3D image. Based on the detected user input, the display system may alter the primary 3D image, which may in turn alter the secondary 3D image produced by the optical system. This type of feedback mechanism allows one or more users to interact with and provide user input to the projected 3D image in mid-air.

The optical system may include an assembly of first and second opposing parabolic mirrors. The display system may be a projector system that includes one or more light sources for projecting a 3D image into a medium such as a non-linear optical material. The non-linear optical material may be located between the opposing parabolic mirrors. Due to the optical properties of the parabolic mirrors, the image being displayed between the parabolic mirrors may be projected through an opening in one of the mirrors and may appear to float in mid-air just outside of the mirror assembly. The image created by the display system may sometimes be referred to as a primary 3D image, whereas the optical illusion created by the optical system may sometimes be referred to as a secondary 3D image projection.

The sensor system may include one or more sensors such as optical sensors for detecting, tracking, and/or monitoring user interaction with the secondary image projection. User interaction may refer to a gesture or other movement performed by a user within a vicinity of the secondary image projection. A gesture may correspond to stationary or non-stationary, single or multiple, touches or near touches on the secondary image projection. Because the secondary image projection is an optical illusion, a “touch” may refer to the placement of a user's finger or other object within a certain distance of the secondary image projection. A gesture may be performed by moving one or more fingers or other objects in a particular manner within the vicinity of the secondary image projection. A gesture may be characterized by, but is not limited to, a pinching, sliding, swiping, rotating, flexing, dragging, or tapping motion between or with one or more fingers. A single gesture may be performed with one or more hands, one or more objects, by one or more users, or any combination thereof.

The interactive display system may include control circuitry that may be used to drive the projector system with graphical data to display a graphical user interface (GUI). The GUI may be projected by the projector system into the projection medium within the mirror assembly, which may in turn produce the GUI as the secondary image projection outside of the mirror assembly. The control circuitry may receive detected user input from the sensor system and may provide corresponding graphical data to the projector system, thereby allowing users to control the secondary image projection via the GUI.

The GUI may include graphical elements displayed at particular locations within the interface. Graphical elements may include, but are not limited to, a variety of displayed virtual input devices including virtual scroll wheels, virtual keyboards, virtual knobs, virtual buttons, any virtual UI, and the like. A user may perform gestures at one or more particular locations on the secondary image projection which may be associated with the graphical elements of the GUI. In other embodiments, the user may perform gestures at one or more locations that are independent of the locations of the graphical elements of the GUI. Gestures performed on or near the secondary image projection may directly or indirectly manipulate, control, modify, move, actuate, initiate, or generally affect graphical elements such as cursors, icons, media files, lists, test, all or portions of images, or the like within the GUI.

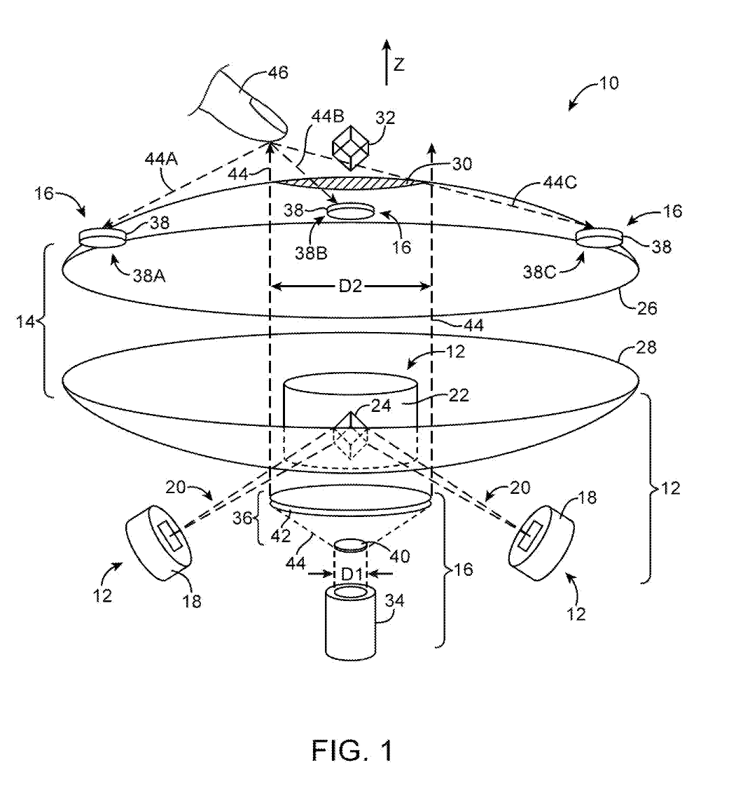

An illustrative interactive display system that may be used to display 3D images with which one or more users may interact is shown in FIG. 1. As shown in FIG. 1, interactive display system 10 may include a display system such as a projector system 12, an optical system such as optical system 14, and a sensor system such as sensor system 16. Projector system 12 may include one or more projectors such as projectors 18 that project an image into a medium such as projection medium 22. Projectors 18 may be configured to project still and/or video images in two and/or three dimensions. Projectors 18 may be laser based projectors, organic light-emitting diode (OLED) based projectors, digital light processing (DLP) unit based projectors, liquid crystal display (LCD) based projectors, or other suitable projectors capable of modulating or directing light from a light source to generate a still or video image.

Projectors 18 may, for example, be laser projectors that modulate laser beams such as laser beams 20 to project an image into projection medium 22. With this type of configuration, each projector 18 may include an acousto-optical modulator for introducing a video signal into laser beam 20 and a rotary polygonal mirror or piezo-driven mirror for providing laser beam 20 with horizontal refresh.

The example of FIG. 1 in which display system 10 includes two projectors 18 that emit light 20 into projection medium 22 is merely illustrative. If desired, there may be one, two, three, four, or more than four projectors in display system 12. Each projector 18 may include a single monochromatic laser, may include multiple monochromatic lasers of the same color, or may include multiple monochromatic lasers of different colors such as a red, green, and blue for producing color images.

If desired, other types of 3D display technologies may be used in display system 12. For example, display structures 12 may include volumetric display elements such as a multiplanar or rotating panel display, holographic display structures, integral imaging display structures, re-imaging display structures, parallax display structures, or other suitable display structures capable of displaying 3D images. The example of FIG. 1 in which display system 12 includes a laser projection system is merely illustrative.

Light 20 emitted from projectors 18 may, for example, be infrared light having a wavelength of about 1 micron or other suitable wavelength in the infrared range of the electromagnetic spectrum. This is, however, merely illustrative. If desired, projectors 18 may emit light of other wavelengths such as visible light having wavelengths from about 390 to 750 nanometers. Configurations in which projectors 18 are infrared laser projectors that emit infrared light 20 are sometimes described herein as an example.

Projectors 18 may emit light 20 into projection medium 22. Projection medium 22 may be a non-linear optical material such as lithium niobate crystal, barium titanate crystal, or other suitable photorefractive material. Non-linear optical material 22 may serve as an optical frequency up-converter configured to mix coherent beams of light such as light beams 20. When first and second coherent beams of light intersect within material 22, material 22 may mix the beams of light to generate light of a higher frequency than that of the original light beams. Thus, when infrared light beams 20 from laser projectors 18 intersect within material 22, the infrared light beams 20 may be frequency up-converted to the visible spectrum, thereby creating a visible image such as primary image projection 24.

Optical system 14 may include an assembly of mirrors such as mirror 26 and mirror 28. As shown in FIG. 1, mirrors 26 and 28 may be concave mirrors such as parabolic mirrors having reflective surfaces that face each other. Mirror 28 may have a reflective surface that faces away from projectors 18, whereas mirror 26 may have a reflective surface that faces towards projectors 18. Mirrors 26 and 28 may sometimes be referred to respectively as “upper mirror” 26 and “lower mirror” 28, however it should be understood that the configuration of FIG. 1 may be implemented in any other suitable orientation (e.g., mirrors 26 and 28 may have principal axes that lie perpendicular to the Z-axis of FIG. 1 or may have principal axes that lie at any other suitable angle with respect to the Z-axis of FIG. 1).

Non-linear optical material 22 may be interposed between mirrors 26 and 28, located on or just above the reflective surface of lower mirror 28. Projectors 18 may produce primary image projection 24 within optical material 22 by directing laser beams through lower mirror 24 into optical material 22. Lower mirror 28 and/or upper mirror 26 may be frequency selective. For example, lower mirror 28 and/or upper mirror 26 may be configured to pass infrared light while reflecting visible light or light of other wavelengths (as an example). Because projectors 18 are infrared laser projectors, infrared light beams 20 may be configured to pass through lower mirror 28 to reach non-linear optical material 22. When light beams 20 intersect within non-linear optical material 22, the infrared light may be frequency up-converted to visible light to produce primary 3D image 24 within material 22.

As shown in FIG. 1, upper mirror 26 may have an opening such as opening 30 in the central portion of mirror 26. Due to the optical properties of parabolic reflectors, light rays from primary 3D image 24 within material 22 may reach upper mirror 26, may be reflected to lower mirror 28, and may ultimately be reflected out of the mirror assembly through opening 30 in upper mirror 26. A hologram-like illusion of the primary 3D image may appear at or just above opening 30 in upper mirror 26, as indicated by secondary 3D image projection 32 of FIG. 1.

Secondary 3D image projection 32 may be identical or nearly identical to primary 3D image 24. Any still images or video images that are projected into material 22 within optical assembly 14 may therefore appear outside of optical assembly 14 through opening 30. Secondary image projection 32 may be observed without any special viewing aid and may be viewed from various viewing angles. Because secondary image projection 32 is an optical illusion and because the image floats in mid-air (e.g., without a special projection medium), an observer may “touch” or reach inside of image 32 without disturbing or optically distorting image 32.

In order to provide an observer with an interactive display experience, display system 10 may include a detection system such as 3D sensor system 16. As shown in FIG. 1, sensor system 16 may include a laser such as laser 34, a beam expander such as laser beam expander 36, and a network of sensors such as sensors 38.

As shown in FIG. 1, infrared laser 34 may be located below lower mirror 28 (e.g., lower mirror 28 may be interposed between upper mirror 26 and laser 34). Laser 34 may emit a beam such as beam 44 of infrared light in the Z-direction towards mirror assembly 14. If desired, other types of lasers may be used in sensor system 16. For example, laser 34 may be a visible light laser, an ultraviolet (UV) laser, an X-ray laser, or other suitable type of laser. The example in which laser 34 is an infrared laser that emits infrared light 44 is merely illustrative and is sometimes described herein as an example.

Beam expander 36 may be interposed between laser 34 and lower mirror 28. Beam expander 36 may include an input lens such as negative input lens 40 and an output lens such as positive output lens 42. Infrared light beam 44 may travel from laser 34 towards negative input lens 40 and may initially have a first diameter such as diameter D1. Upon passing through negative input lens 40, beam 44 may begin to diverge and may continue to diverge until it passes through positive output lens 42. Upon passing through positive output lens 42, beam 44 may return to a collimated form having a second diameter such as diameter D2 (e.g., a diameter larger than initial diameter D1). Diameter D2 may, for example, be equal to or less than the diameter of opening 30 in upper mirror 26. If desired, other types of beam expanders may be used to expand the laser beam emitted by laser 34. The example of FIG. 1 is merely illustrative.

When infrared light beam 44 strikes an external object such as external object 46 (e.g., a user's finger or other external object), light 44 may be reflected. As shown in FIG. 1, light 44 incident on finger 46 is reflected towards sensors 38. Sensors 38 may be optical sensors (e.g., image sensors such as CMOS image sensors, cameras, other light-based sensors, etc.), may be acoustic-based sensors such as ultrasonic acoustic-based sensors, may be capacitive sensors, or may be any other suitable type of sensor configured to determine the location and/or to track the motion of finger 46 in three dimensions relative to image 32. Sensors 38 may, for example, be light-based sensors such as CMOS detectors having a band-pass filter centered at the infrared wavelength of laser beam 44.

In one suitable embodiment, detectors 38 may be configured to detect a phase shift of an incoming signal with respect to a reference signal. For example, reflection at finger 46 of FIG. 1 may induce a phase shift in the reflected light rays such as reflected light rays 44A, 44B, and 44C. Detector 38A may detect the phase shift associated with reflected light ray 44A, detector 38B may detect the phase shift associated with reflected light ray 44B, and detector 38C may detect the phase shift associated with reflected light ray 44C. Based on this information, the location of finger 46 may be determined (e.g., using trilateration, triangulation, other locating methods, or a combination thereof).

In another suitable embodiment, each detector 38 may be configured to detect the angle of incoming light rays with respect to the detector's line of sight. Given a known distance between detector 38 and light source 34, this information may be used to determine the relative position of finger 46 (e.g., using triangulation or other suitable locating methods).

These examples are merely illustrative, however. In general, any suitable positioning technology may be used in display system 10 to locate and/or track the motion of external objects such as finger 46.

The location and/or motion of external object 46 detected by sensor system 16 may be recognized as user input. Control circuitry in display system 10 may be configured to interpret the user input and to provide corresponding graphical data to projectors 18 based on the user input. Sensor system 16 may therefore provide a feedback mechanism that allows the movements and/or gestures of one or more observers to be interpreted as user input that may be used to select, translate, and manipulate images 32, to control the operation of display system 10, etc.

If desired, display system 10 may not be interactive. For example, display system 10 may disable or may otherwise not include sensor system 16 for detecting user input. The example of FIG. 1 in which display system is an interactive display system that includes a feedback mechanism to allow users to provide user input to control and manipulate projection 32 is merely illustrative and is sometimes described herein as an example.

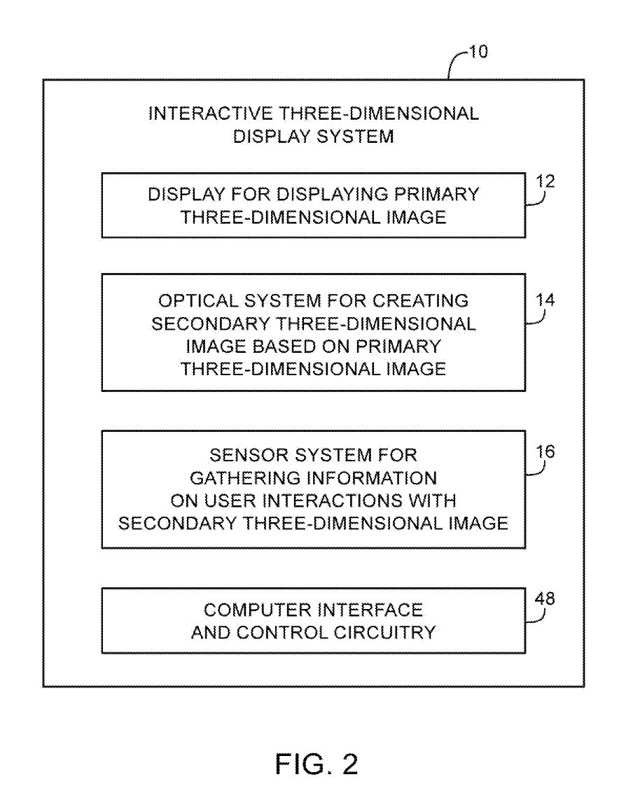

A schematic diagram of an illustrative interactive display system of the type shown in FIG. 1 is shown in FIG. 2. As shown in FIG. 2, interactive 3D display system 10 may include a display such as display 12 for displaying 3D images. Display 12 may be a projector system of the type shown in FIG. 1. For example, display 12 may include one or more laser projectors that project a 3D image in a non-linear optical material such as a non-linear crystal or other photorefractive material. This is, however, merely illustrative. In general, any suitable 3D display technology may be used in forming display 12. For example, display 12 may be a volumetric display such as a multiplanar or rotating panel display, a holographic display, an integral imaging display, a re-imaging display, a parallax display, or other suitable display capable of displaying 3D images.

Interactive display system 10 may also include an optical system such as optical system 14 for creating a secondary 3D image based on the primary 3D image displayed by display 12. Optical system 14 may include an assembly of mirrors of the type shown in FIG. 1. For example, optical system 14 may include first and second opposing parabolic reflectors that surround or partially surround the primary 3D image displayed by display 12. Light emitted by the primary 3D image may be reflected back and forth between the two parabolic reflectors until it ultimately exits through an opening in one of the parabolic reflectors, thereby creating a secondary 3D image. The secondary 3D image created by optical system 14 may be an image that appears identical or nearly identical to the primary 3D image produced by display 12. This is, however, merely illustrative. If desired, other types of optical structures (e.g., optical structures such as plane mirrors, convex mirrors, concave mirrors, lenses, reflectors, etc.) may be used in forming optical system 14.

A sensor system such as sensor system 16 may be used to gather information on user interactions with the secondary 3D image created by optical system 14. Sensor system 16 may include a detection system of the type shown in FIG. 1. For example, sensor system 16 may include an emitter such as emitter 34 and a network of detectors such as detectors 38 (FIG. 1). Sensor system 16 may be configured to detect the presence and/or motion of one or more users interacting with the 3D image. The information gathered by sensor system 16 may be interpreted as user input that may in turn be used to select, translate, and manipulate images produced by display 12 and optical system 14.

As shown in FIG. 2, interactive display system 10 may include computing equipment such as computer interface and control circuitry 48. Computer interface and control circuitry 48 may include storage and processing circuitry for controlling the operation of display system 10. Computer interface and control circuitry 48 may, for example, include storage such as hard disk drive storage, nonvolatile memory (e.g., flash memory or other electrically-programmable-read-only memory configured to form a solid state drive), volatile memory (e.g., static or dynamic random-access-memory), etc. Computer interface and control circuitry 48 may include processing circuitry based on one or more microprocessors, microcontrollers, digital signal processors, baseband processors, power management units, audio codec chips, application specific integrated circuits, etc.

Computer interface and control circuitry 48 may, for example, include control circuitry for controlling display 12, optical system 14, and/or sensor system 16. Computer interface and control circuitry 48 may be used to run software in display system 10, such as operating system software and application software. Using this software, computer interface and control circuitry 48 may present information to a user of display system 10 by controlling the graphical data that is provided to display 12. When presenting information to a user of display system 10, sensor signals from sensor system 16 and other information may be used by computer interface and control circuitry 48 in making adjustments to the graphical data that is used for display 12.

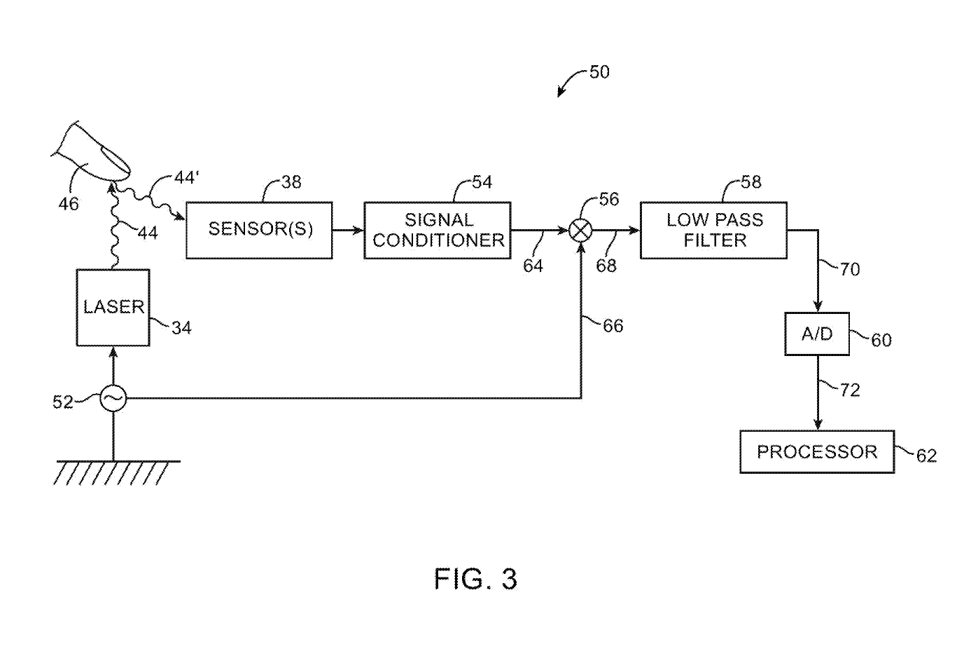

FIG. 3 is a diagram of illustrative circuitry such as circuitry 50 that may be used in implementing sensor system 16 in display system 10. If desired, all or portions of circuitry 50 may form part of computer interface and control circuitry 48 of FIG. 2 or may be separate from computer interface and control circuitry 48.

As shown in FIG. 3, a local oscillator (LO) such as local oscillator 52 may be electrically coupled to laser 34. Local oscillator 52, which may operate in the Gigahertz range, may be configured to modulate the magnitude of the signal transmitted by laser 34 such as optical signal 44. Optical signal 44 may, for example, be a laser beam having a wavelength in the infrared range. This is, however, merely illustrative. If desired, optical signal 44 may have other suitable wavelengths.

Upon striking an external object such as external object 46 (e.g., a user's finger or other external object), optical signal 44 may be reflected and may, as a result, experience a shift in phase. Reflected optical signal 44′ may therefore carry an associated phase shift φ relative to transmitted optical signal 44.

One or more sensors such as sensor 38 may receive reflected optical signal 44′ and may provide the received signal to a signal conditioner such as signal conditioner 54. Signal conditioner 54 may be configured to remove noise and spurious signals. Following removal of noise and spurious signals, signal conditioner 54 may provide an input signal to a mixer such as mixer 56 over signal line 64. The input signal provided to mixer 56 over line 64 may be proportional to reflected optical signal 44′ and may take the form of the following sinusoidal signal:

sin(ω_{LO}t+φ) (1)

wherein ω_{LO} is the local oscillator frequency (e.g., a frequency in the Gigahertz range), t is time, and φ is the phase shift of reflected optical signal 44′ with respect to transmitted optical signal 44.

In addition to receiving input signal (1) from signal conditioner 54, mixer 56 may also receive an input signal from local oscillator 52 over signal line 66. The input signal provided to mixer 56 over line 66 may take the form of the following sinusoidal signal:

sin(ω_{LO}t) (2)

Mixer 56 may combine input signal (1) with input signal (2) and may provide the combined signal to a low pass filter such as low pass filter 58 over signal line 68. The process of combining or mixing two frequencies is sometimes referred to as heterodyning. The combined signal provided to low pass filter 58 over signal line 68 may be the product of signal (1) and signal (2) and may therefore have the following form:

sin(ω_{LO}t+φ)sin(ω_{LO}t) (3)

Using trigonometric identities on which heterodyning is based, combined signal (3) is equivalent to the following:

$$\frac{1}{2} cos ( {ω}_{LO} t - ϕ - {ω}_{LO} t ) - \frac{1}{2} cos ( {ω}_{LO} t + ϕ + {ω}_{LO} t ) \qquad ( 4 )$$

The first term in signal (4) is a DC signal, whereas the second term in signal (4) is a high frequency signal. Low pass filter 58 may be configured to filter out the high frequency signal represented by the second term in signal (4). The signal output by low pass filter 58 on signal line 70 may therefore be proportional to the following:

cos(φ) (5)

Low pass filter 58 may provide signal (5) or a signal proportional to signal (5) to an analog-to-digital converter such as analog-to-digital converter 60 over signal line 70. Analog-to-digital converter 60 may digitize incoming signals from low pass filter 58 and may provide corresponding digital signals to a processor such as processor 62 over signal line 72.

Processor 62 may be configured to determine the location of finger 46 based on signals received over signal line 72. For example, signal (5) may be used in determining the location of finger 46 relative to sensors 38. In configurations where three sensors 38 each receive a respective reflected optical signal 44′, the distances between finger 46 and each of the three sensors 38 may be derived based on the phase shift associated with each reflected optical single 44′. A method known as geometric trilateration may be used to determine the relative or absolute location of finger 46 in three dimensions by analyzing the determined distances between each of the three sensors 38 and finger 46. If desired, other locating methods such as triangulation may be used to determine the location of finger 46. The example in which processor 62 determines the location of finger 46 by means of geometric trilateration is merely illustrative.

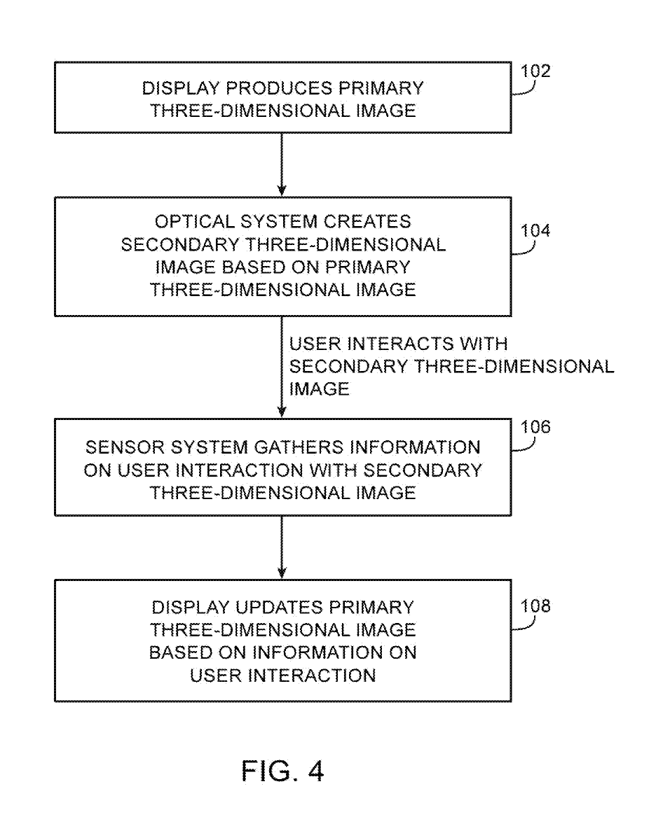

FIG. 4 is a flow chart of illustrative steps involved in operating an interactive display system such as interactive display system 10 if FIGS. 1 and 2.

At step 102, a display such as display structures 12 of FIG. 1 may display a 3D image (sometimes referred to as the primary 3D image). This may include, for example, using laser projectors such as laser projectors 18 of FIG. 1 to project still and/or video images in a projection medium such as a non-linear crystal.

At step 104, an optical system such as optical system 14 of FIG. 1 may use the 3D image produced during step 102 to create in mid-air a 3D image with which a user may interact. The 3D image (sometimes referred to as the secondary 3D image) may appear identical or nearly identical to the primary 3D image produced during step 102. The secondary 3D image created during step 104 may be viewable from various viewing angles and may not require any special viewing aid.

At step 106, a sensor system such as sensor system 16 of FIG. 1 may gather information on user interaction with the secondary 3D image. This may include, for example, using circuitry of the type shown in FIG. 3 to determine the relative or absolute location of a user, of a user's finger, or of other external objects. Step 106 may also include interpreting information gathered by sensor system 16 to determine the type of user input being received. For example, user gestures (e.g., swiping, pinching, pointing, pressing, other gestures, etc.) may be used to select, translate, and manipulate the secondary 3D image and/or to control the operation of display system 10.

At step 108, display 12 may update the primary 3D image based on the information gathered by sensor system 10. This may include, for example, changing and/or updating the appearance and/or the content of images displayed by display 12. Because the secondary 3D image is a projection of the primary 3D image, changes and/or updates to the primary 3D image may in turn be imposed on the secondary 3D image. In this way, one or more users may interact with and provide user input to the secondary 3D image as it “floats” in mid-air.

The foregoing is merely illustrative of the principles of this invention and various modifications can be made by those skilled in the art without departing from the scope and spirit of the invention.

What is claimed is:

1. A method, comprising:
displaying a primary three-dimensional image;
with an optical system, using the primary three-dimensional image to create a secondary three-dimensional image with which a user interacts; and
gathering information on user interactions with the secondary three-dimensional image using sensors.

2. The method defined in claim 1 further comprising:
updating the primary three-dimensional image based on the information on user interactions.

3. The method defined in claim 1 wherein using the primary three-dimensional image to create the secondary three-dimensional image comprises creating the secondary three-dimensional image in mid-air based on the primary three-dimensional image.

4. The method defined in claim 1 wherein displaying the primary three-dimensional image comprises:
with at least one laser, emitting light into a non-linear optical material to form the primary three-dimensional image in the non-linear optical material.

5. The method defined in claim 1 wherein the optical system comprises an assembly of mirrors and wherein using the primary three-dimensional image to create the secondary three-dimensional image comprises:
with the assembly of mirrors, reflecting light emitted from the primary three-dimensional image to a location in mid-air to create the secondary three-dimensional image.

6. The method defined in claim 1 wherein the sensors comprise a plurality of light sensors and wherein gathering information on user interactions with the secondary three-dimensional image comprises:
with the plurality of light sensors, detecting an optical signal that reflects off an external object.

7. The method defined in claim 6 further comprising:
with control circuitry, determining a location of the external object based on the optical signal.

8. The method defined in claim 7 further comprising:
updating the primary three-dimensional image based on the location of the external object.

9. An interactive three-dimensional display system, comprising:
a display system configured to produce a primary three-dimensional image;
an optical system configured to create a secondary three-dimensional image based on the primary three-dimensional image; and
a sensor system configured to detect user interaction with the secondary three-dimensional image.

10. The interactive three-dimensional display system defined in claim 9 further comprising control circuitry configured to update the primary three-dimensional image based on the user interaction.

11. The interactive three-dimensional display system defined in claim 9 wherein the display system comprises at least one laser and a non-linear optical material and wherein the at least one laser projects the primary three-dimensional image into the non-linear optical material.

12. The interactive three-dimensional display system defined in claim 11 wherein the non-linear optical material comprises a non-linear crystal and wherein the at least one laser comprises an infrared laser.

13. The interactive three-dimensional display system defined in claim 9 wherein the optical system comprises:
a first curved mirror having a first reflective surface;
a second curved mirror having a second reflective surface, wherein the second reflective surface reflects light towards the first reflective surface.

14. The interactive three-dimensional display system defined in claim 13 wherein at least one of the first and the second curved mirrors is configured to pass infrared light and to block visible light.

15. The interactive three-dimensional display system defined in claim 13 wherein the primary three-dimensional image is produced between the first and second curved mirrors.

16. The interactive three-dimensional display system defined in claim 15 wherein at least one of the first and the second curved mirrors comprises an opening and wherein the optical system is configured to create an optical illusion of the primary three-dimensional image through the opening to form the secondary three-dimensional image.

17. The interactive three-dimensional display system defined in claim 9 wherein the sensor system comprises:
an infrared laser configured to emit infrared light; and
a plurality of sensors configured to detect the infrared light.

18. A display system, comprising:
display structures on which an image is displayed;
a mirror assembly at least partially surrounding the image, wherein the mirror assembly is configured to project the image in mid-air; and
a detection system for detecting user interaction with the projected image.

19. The display system defined in claim 18 wherein the mirror assembly comprises first and second parabolic reflectors.

20. The display system defined in claim 18 wherein the detection system comprises at least three optical sensors and wherein the detection system is configured determine a location of an external object relative to the projected image using the at least three optical sensors.

21. The display system defined in claim 18 wherein the image is a three-dimensional image and wherein the display structures comprise a laser projection system for creating the three-dimensional image.

22. The display system defined in claim 21 further comprising:
control circuitry configured to receive user input information from the detection system and to provide graphical data to the laser projection system based on the user input information.
